(19) United States
(12) Patent Application Publication
(10) Pub. No.: US 2014/0022358 A1
(43) Pub. Date: Jan. 23, 2014

(54) PRISM CAMERA METHODS, APPARATUS, AND SYSTEMS

(71) Applicants: Chandra Kambhamettu, Newark, DE (US); Gowri Somanath, Newark, DE (US); Rohith Mysore Vijaya Kumar, Newark, DE (US)

(72) Inventors: Chandra Kambhamettu, Newark, DE (US); Gowri Somanath, Newark, DE (US); Rohith Mysore Vijaya Kumar, Newark, DE (US)

(73) Assignee: Univeristy of Delaware, Newark (DE)

(21) Appl. No.: 13/989,964

(22) PCT Filed: Nov. 29, 2011
(86) PCT No.: PCT/US11/62314

§ 371 Date: Sep. 30, 2013

Related U.S. Application Data
(60) Provisional application No. 61/417,570, filed on Nov. 29, 2010.

(51) Int. Cl. H04N 13/02

(52) U.S. Cl. CPC H04N 13/0217
USPC 348/49

(57) ABSTRACT

Methods, system, and apparatus for generating depth maps are described. A depth map may be generated by obtaining a transformation for a prism camera having a still image capture mode and a video mode (the transformation based on the difference between the still image transfer mode and the video mode), capturing a multi-view still image with the camera, capturing multi-view video images with the camera, and generating a resolved video depth map from the transformation, the multi-view still image, and the multi-view video. The depth map may be converted to a 3D structure. Multiple resolved 3D structures from prism camera apparatus may be combined to generate volumetric reconstruction of the scene.

### CROSS-REFERENCE TO RELATED APPLICATION

This application claims priority to U.S. Provisional Patent Application No. 61/417,570, filed Nov. 29, 2010, the contents of which are incorporated by reference herein in their entirety.

### STATEMENT REGARDING FEDERALLY SPONSORED RESEARCH

This invention was made with government support under contract number ANT0636726 awarded by the National Science Foundation. The government may have rights in this invention.

### BACKGROUND OF THE INVENTION

Stereo and three-dimensional (3D) reconstructions are used by many applications such as object modeling, facial expression studies, and human motion analysis. Typically, multiple high frame rate cameras are used to obtain stereo images. Special hardware and/or sophisticated software is generally used, however, to synchronize such multiple high frame rate cameras.

### SUMMARY OF THE INVENTION

The present invention is embodied in methods, system, and apparatus for generating depth maps, 3D structures and volumetric reconstructions. In accordance with one embodiment, a depth map is generated by obtaining a transformation for a camera having a still image capture mode and a video mode (the transformation providing image translation and scaling between the still image transfer mode and the video mode), capturing at least one multi-view still image with the camera, capturing multi-view video with the camera, estimating relative depth values through stereo matching of the still images, and generating a resolved video depth map from the transformation, the at least one multi-view still image, and the multi-view video images. The multi-view still image may be a stereo still image and the multi-view video images may be stereo video. Multiple 3D structures from multiple prism camera apparatus may be combined to generate a volumetric reconstruction (3D image scene).

An embodiment of an apparatus for generating a depth map includes a camera having a lens (the camera having a still capture mode and a video capture mode), a prism positioned in front of the lens having a first surface, a second surface, and a third surface, the first surface facing the lens, a first mirror positioned proximate to the second surface of the prism, and a second mirror positioned proximate to the third surface of the prism. The apparatus may include a processor configured to generate a resolved video depth map from a transformation for the camera, at least one multi-view still image from the camera, and multi-view video from the camera. Two or more apparatus may be combined to form a system for generating a volumetric reconstruction.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following figures:

FIG. 1 is a perspective view of an exemplary prism stereo camera in accordance with an aspect of the present invention;

FIG. 2 is a top illustrative view illustrating operation of the prism stereo camera of FIG. 1;

FIG. 3 is an enlarged partial illustrative view of the illustrative view of FIG. 2;

FIG. 4 is a block diagram illustrating a rig camera system utilizing multiple prism cameras to generate a volumetric 3D image scene including an object in accordance with an aspect of the present invention;

FIG. 5 is a flow diagram illustrating generation of a resolved video depth map in accordance with aspects of the present invention;

FIG. 6 is a flow diagram for 3D structure recovery from an image captured using a prism camera;

FIG. 7 is a flow diagram for volumetric reconstruction from images captured using multiple prism cameras; and

FIG. 8 is an illustration of the alignment of two exemplary 3D structures.

### DETAILED DESCRIPTION OF THE INVENTION

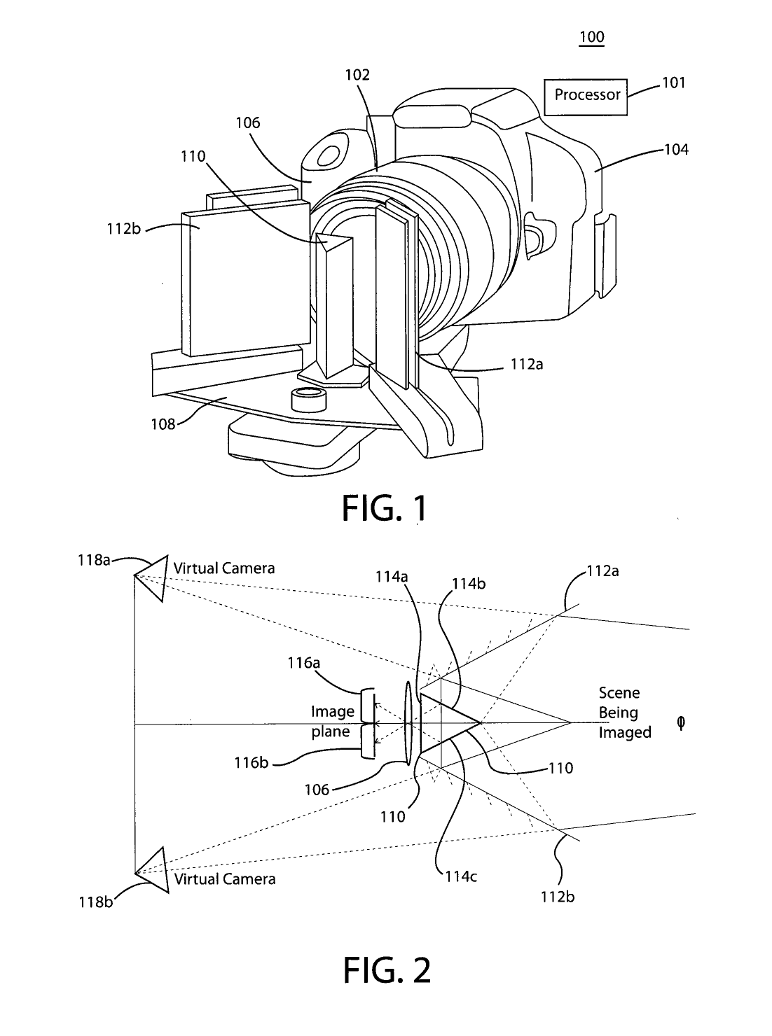

FIGS. 1 and 2 depict an exemplary prism stereo camera 100 in accordance with an aspect of the present invention. The prism camera 100 includes a processor 101 and a camera 102 having a camera body 104 and a lens 106. A prism and mirror assembly 108 is mounted to the camera 102. The assembly 108 includes a prism 110, a first mirror 112a, and a second mirror 112b positioned in front of the lens 106. The prism 110 includes a first surface 114a facing the lens 106, a second surface 114b proximate the first mirror 112a, and a third surface 114c proximate the second mirror 112b. In an exemplary embodiment, the assembly 108 is adjustable such that the position of the prism 110 and mirrors 112 can be adjusted to modify the convergence (vergence) and/or effective baseline (B) of the prism camera 100. The illustrated prism 110 is an equilateral prism that is two inches in height with each side measuring one inch and the mirrors 112 are two inch squares. An exemplary camera is a digital single-lens reflex camera (DSLR) having a still image capture mode capable of 15 MP still images at 1 frame per second (fps) and a video capture mode capable of capturing 720 lines of video at 30 fps.

FIG. 2 illustrates operation of the prism camera 100 to image a scene. In an exemplary embodiment, light from a scene being imaged impinges on the first mirror 112a. The first mirror 112a reflects the light toward the second surface 114b of prism 110. The light passes through the second surface 114b and is reflected within the prism 110 by the third surface 114c. The reflected light passes through the first surface 114a toward lens 106, which focuses the light on a first portion 116a of an imaging device (e.g., a charge coupled device (CCD) within camera 102).

Simultaneously, light from the scene being imaged impinges on the second mirror 112b. The second mirror 112b reflects the light toward the third surface 114c of prism 110. The light passes through the third surface 114c and is reflected within the prism 110 by the second surface 114b. The reflected light passes through the first surface 114a toward lens 106, which focuses the light on a second portion 116b of an imaging device (e.g., a charge coupled device (CCD) within camera 102).

As depicted in FIG. 2, the image captured in the first portion 116a of the imaging device is essentially equivalent to what would be imaged by a first camera (i.e., virtual camera 118a) and the image captured in the second portion 116b of the imaging device is essentially equivalent to what would be imaged by a second camera (e.g., virtual camera 118b) separated from the first camera by an effective baseline (B).

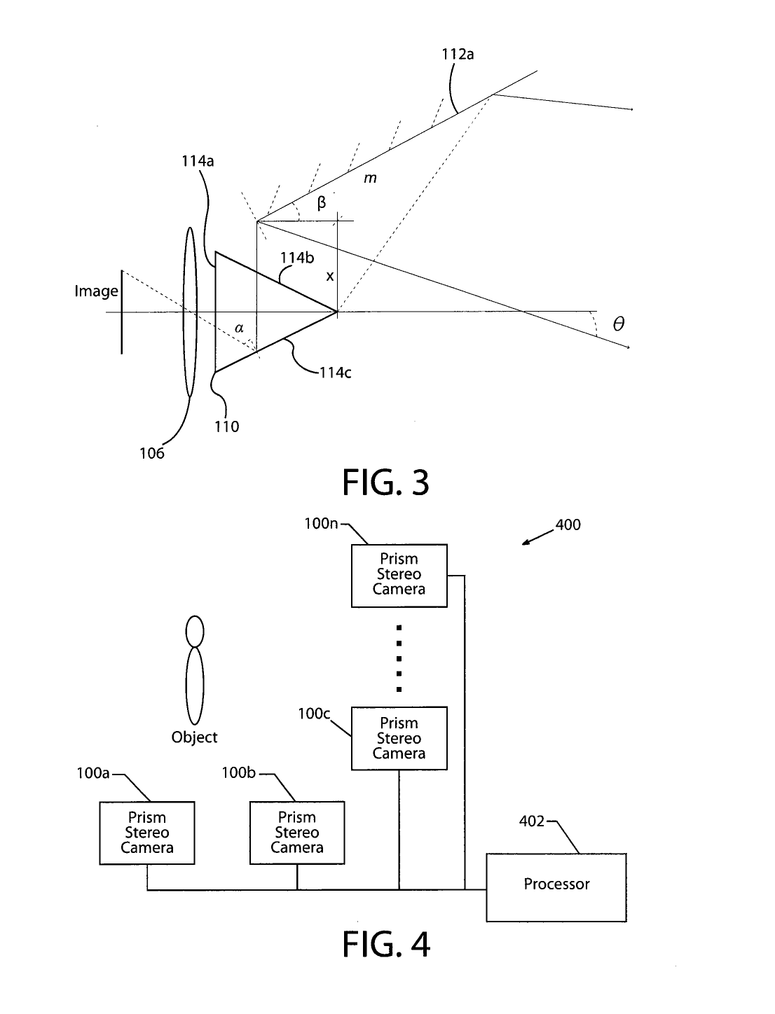

FIG. 3 depicts the passage of light via the first mirror 112a in greater detail. The horizontal line passing through the center of the imaging device and the lens is the principal axis of the camera. The angles and distances are defined as follows: φ (FIG. 2) is the horizontal field of view of camera in degrees, α is the angle of incidence at prism, β is the angle of inclination of mirror, θ is the angle of scene ray with the principal axis, x is the perpendicular distance between each mirror and the principal axis, m is the mirror length and B is the effective baseline (FIG. 2). To calculate the effective baseline, the rays may be traced in reverse. Considering a ray starting from the image sensor, passing through the camera lens 106 and incident on the prism surface 114a at an angle α. This ray is reflected from the mirror surface 112a towards the scene. The final ray makes an angle of θ with the horizontal as shown in FIG. 3. It can be shown that θ=150−2β−α.

In deriving the above, it is assumed that there is no inversion of the image from any of the reflections. This assumption may be violated at large fields of view. More specifically, φ<60° in the exemplary setup. Since no other lenses apart from the camera lens are used, the field of view in resulting virtual cameras should be half of the real camera.

In FIG. 2, consider two rays from the image sensor, one ray from the central column of the image (α₀=60°) and another ray from the extreme column (α=60°−φ/2). The angle between the two scene rays is then φ/2. For stereo, the images from the two mirrors should contain some common part of the scene. Hence, the scene rays should be towards the optical axis of the camera rather than away from it. Also, the scene rays should not re-enter the prism 110 due to internal reflection as this does not provide an image of the scene. Applying these two conditions, the inclination of the mirror can be bound by the following inequality φ/4<β<45°+φ/4. The effective baseline (B), based on the angle of the scene rays, the mirror length and the distance of the mirror from the axis, can be calculated as follows:

$$B = 2 \frac{x tan ( 2 β - φ / 2 ) - m cos ( β ) - ( x + m cos ( β ) ) tan ( 2 β )}{tan ( 2 β - φ / 2 ) - tan ( 2 β )}$$

In an exemplary setup, the parameters used were a focal length of 35 mm corresponding to φ=17°, β=49.3°, m=76.2 mm, and x=25.4 mm. Varying the mirror angles provides control over the effective baseline as well as the vergence of the stereo imaging system.

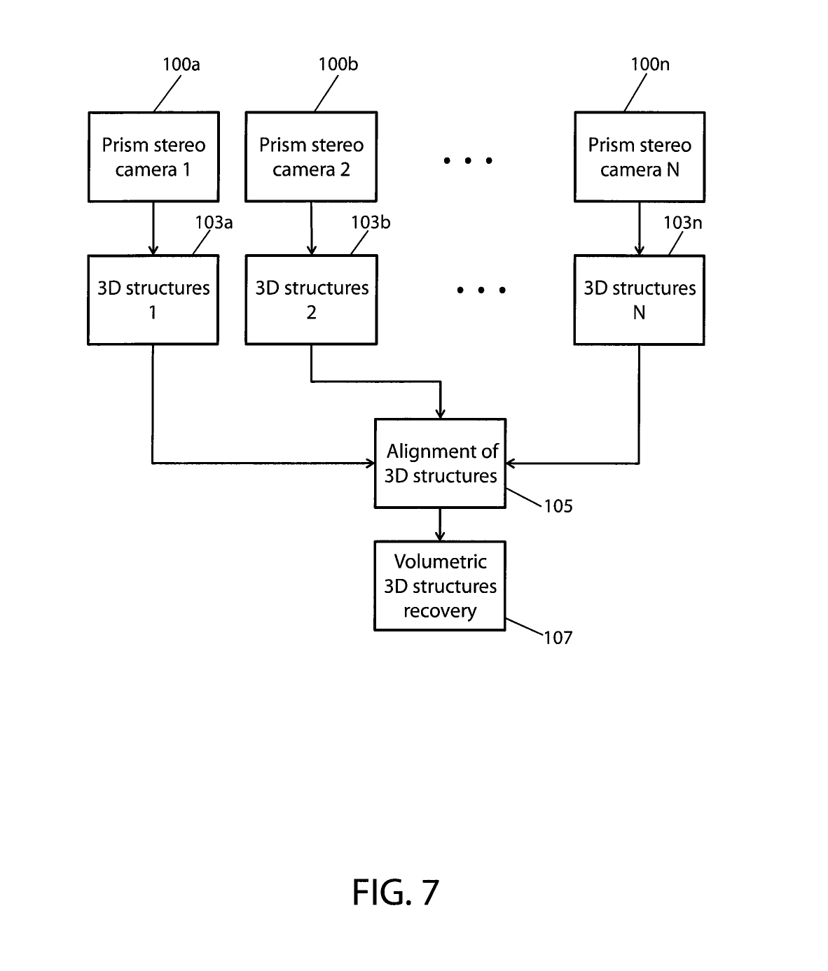

FIG. 4 and FIG. 7 depict a multi prism camera imaging system 400 and a flow diagram for volumetric reconstruction, respectively. Generally speaking, the depicted system employs a plurality of prism cameras 100a-n for obtaining a plurality of 3D structures 103a-n including data representing an image from different viewpoints. A processor 402 combines and aligns the plurality of 3D structures at step 105 to create a volumetric reconstruction at block 107.

Conventional multi-camera systems use single-view cameras rather than stereo cameras due to issues associated with synchronization and re-calibration whenever vergence, zoom, etc. of stereo cameras are changed. Using prism cameras 100 in accordance with the present invention avoids these issues because only a rigid transformation (three dimensional translation and rotation) corresponding to each prism camera 100 is needed for the processor 402 to combine images/frames from multiple cameras, which can be performed using conventional processors. One of skill in the art would understand how to combine images using conventional procedures from the description herein. A rigid transformation may be used to map points in one 3D coordinate system to another such that the distance between the points do not change and the angles between any two straight lines is preserved. An exemplary rigid transformation consists of two parts: a 3×3 rotation matrix R and a 3×1 translation vector T. The mapping (x′,y′,z′) of a point (x,y,z) may be obtained by the following equation:

$$[ \begin{matrix}{x}^{′} \\ {y}^{′} \\ {z}^{′}\end{matrix} ] = R [ \begin{matrix}x \\ y \\ z\end{matrix} ] + T$$

For a pair of prism cameras, these transformations can be obtained by capturing images of scene with both the cameras; estimating 3D structures from both the prism cameras independently; obtaining correspondences between images from the cameras; and obtaining the matrix R and the vector T that provide the optimal mapping between the corresponding points.

An optimal estimate of the transformation is obtained using a least squares process. For a given set of points (x1,y1,z1), . . . (xn,yn,zn) with correspondences, the transformation is estimated by solving the following least squares problem:

$${\sum }_{i = 1}^{n} R [ \begin{matrix}{x}_{i} \\ {y}_{i} \\ {z}_{i}\end{matrix} ] + T - [ \begin{matrix}{x}_{i}^{′} \\ {y}_{i}^{′} \\ {z}_{i}^{′}\end{matrix} ] .$$

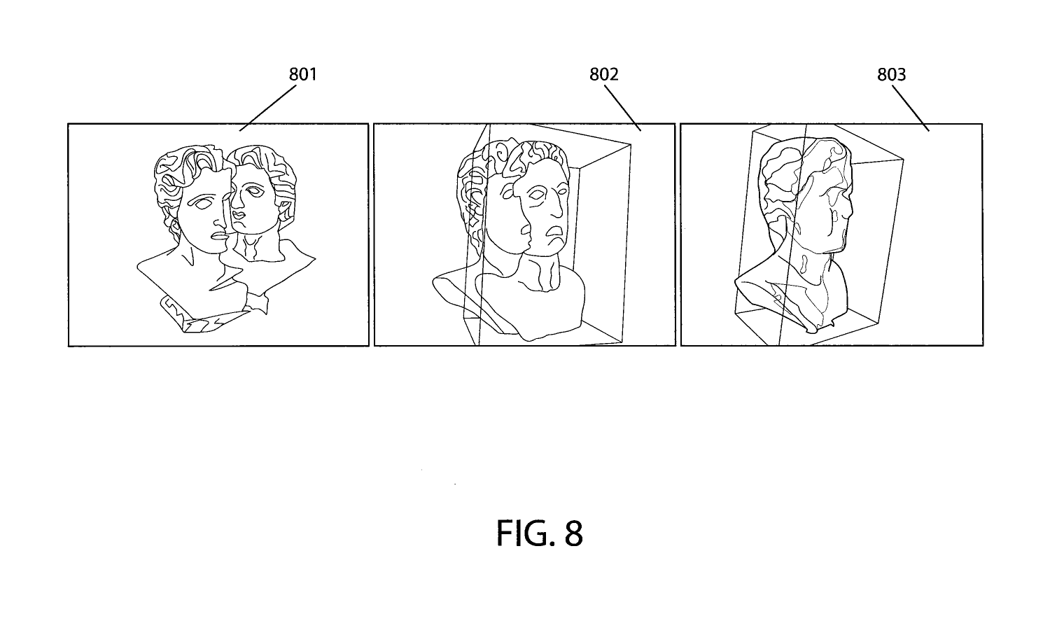

An illustration of the alignment process is shown in FIG. 8. The image 801 on the left-side of FIG. 8 shows two views of an exemplary object that are not aligned. The image 802 in the center of FIG. 8 shows the approximate alignment using rigid transformation. The image 803 on the right-side of FIG. 8 shows the two structures after complete alignment.

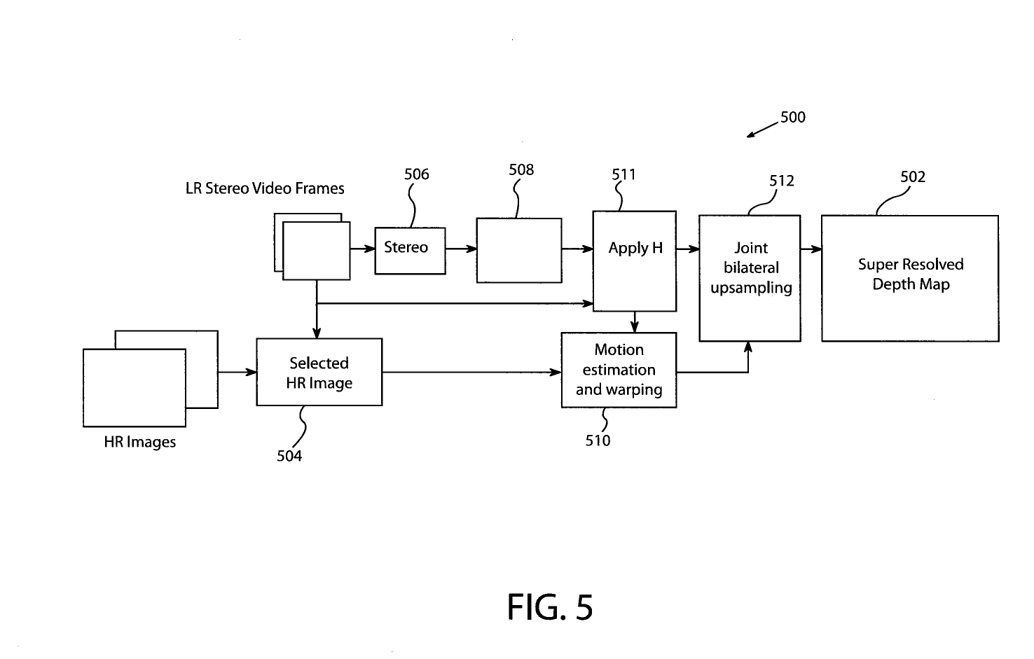

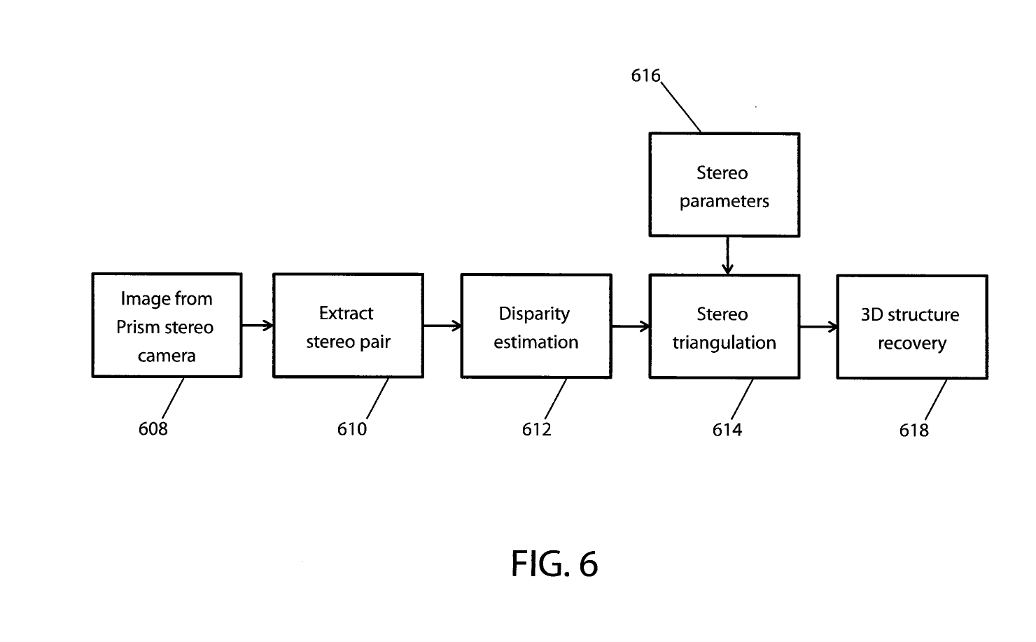

FIG. 5 is a flow diagram 500 depicting exemplary steps for generating a resolved depth map 502 using images captured by a prism camera 100 (FIG. 1) in accordance with embodiments of the present invention that capture both stereo higher resolution still images and lower resolution video frames. In accordance with this embodiment, the depth maps created using the lower resolution video frames can be enhanced, thereby improving the resultant volumetric reconstruction such as described below with reference to FIG. 6.

In an exemplary embodiment, an initial step (not shown) is performed to estimate a homography (H) transformation between low resolution (LR) video frames and high resolution (HR) still images using a known pattern. The transformation accounts for the camera using different portions of the imaging device (CCD array) for still image capture and for video capture, e.g., due to different aspect ratios. In an exemplary embodiment, the H transformation may need to be performed only once for a prism camera 100 because the translation and scale differences between the LR video and the HR still images of a camera is typically fixed once the camera zoom and the prism 110 and mirrors 112 are set. The H transformation may be determined whenever the setup, e.g., zoom or prism/mirrors configuration change. The prism camera 100 captures multi-view (e.g., stereo) low resolution (LR) video and periodically captures high resolution (HR) still images. A HR image is selected for each LR video image that is closest in time to the captured time of the LR video image at block 504. At block 506, each stereo pair is rectified. A disparity map 508 is then obtained using stereo matching. The transformation H is then applied to the disparity map at block 511 to transform the disparity map 508 to the HR image size.

In an exemplary embodiment, the prism camera is configured to capture the images substantially simultaneously, e.g., one still image for every 30 frames of video. The capability to capture both still and video may be required for super-resolution. Certain commercial DSLRs (such as the Canon T1i DSLR) have the capability to capture both still frames and video. In such commercial DSLRs, video is taken continuously and the rate at which still images are captured is adjustable. Other commercial cameras can provide the above capability through same/different means (wireless remote, wired trigger or manual etc). Such capabilities are usually provided by the camera and require the processor to capture both still frames and video in a specific mode. The processor by itself does not perform any specialized task for the above and the triggering process would be same.

At block 510, motion and warping between the selected HR still image and the disparity map 508 are estimated. In an exemplary embodiment, assuming rigid objects in the scene exist, per-object motion between the LR images and the selected HR image are estimated and a scale-invariant feature transform (SIFT) is applied at block 510. The motion compensated HR frame and transformed depth map are then used to up-sample the disparity map at block 512 in a known manner to create the resolved depth map 502.

FIG. 6 is a flow diagram for 3D structure recovery from an image captured from a prism camera. At block 608, images are captured by the prism camera. At block 610, two views which comprise a stereo pair are extracted from the two parts of the imaging device (116a and 116b in FIG. 2). At block 612, the images are processed to obtain the estimate of disparity between them. The process of disparity estimation may be performed by measuring the parallax of pixels (which is dependent on the distance of the scene point from the camera system). Images from the two parts of the imaging device are separated and rectified to contain pixel shifts that are purely horizontal. This process involves application of a perspective transform to the images so that a pixel in the left image corresponds to a pixel in the same row in the right image. If the rectified image from the left half of the imaging device 116a is I_{L} and the image from the right half of the imaging device is I_{R}, then the disparity d at a pixel (x,y) follows the relation:

I_{L}(x+d,y)=I_{R}(x,y).

The disparity may be estimated at each pixel using a method such as a combination of known local and global image matching methods. Suitable methods will be understood by one of skill in the art from the description herein. Such methods are disclosed in the following articles: Rohith M V et al., Learning image structures for optimizing disparity estimation, ACCV'10 Tenth Asian Conference on Computer Vision 2010, 2010; Rohith M V et al., Modified region growing for stereo of slant and textureless surfaces, ISVC2010—6th International Symposium on Visual Computing, 2010; Rohith M V et al., Stereo analysis of low textured regions with application towards sea-ice reconstruction, IPCV'09—The 2009 International Conference on Image Processing, Computer Vision, and Pattern Recognition, 2009; and, Rohith M V et al., Towards estimation of dense disparities from stereo images containing large textureless regions, ICPR 08: Proceedings of the 19th International Conference on Pattern Recognition, 2008.

The method optionally consists of matching each pixel in the right image with a corresponding pixel in the left image under the constraint that the correspondences are smooth. The problem may be posed as a global energy minimization problem where each disparity assignment to each pixel has a cost associated with it. The cost consists of error in matching |I_{L}(x+d,y)−I_{R}(x,y)| and gradient of disparity ∇d. The disparity map is an assignment that minimizes the following energy function

$${\sum }_{( x , y )} \vert {I}_{L} ( x + d , y ) - {I}_{R} ( x , y ) \vert + ∇ d .$$

This energy minimization problem can be solved using known techniques such as graph cuts, gradient descent or region growing techniques. Suitable methods will be understood by one of skill in the art from the description herein. Such methods are described in the above-identified articles. The contents of those article are incorporated by reference herein in their entirety.

The 3D structure is obtained at block 618 from the disparity estimate at block 612 through triangulation at block 614 using the stereo parameters at block 616. At block 614, the process of triangulation consists of projecting two rays for each pair of corresponding pixels in the right and left image. The rays originate at the camera center (focal point of all the rays belonging to the camera) and pass through the chosen pixel. The position in space where the two rays are closest to each other provides an estimate from the scene point they originated. This process is repeated for all pixels in the image to obtain the 3D structure of the scene being imaged. For this, an estimate of stereo parameters are needed.

At block 616, the stereo parameters are estimated. Stereo parameters comprise intrinsic camera parameters including focal lengths, image centers, distortion and also extrinsic parameters comprising baseline and vergence. For each prism camera, the stereo parameters are estimated by capturing calibration images (images of planar objects with a checkerboard pattern placed in varying orientations and positions); detecting corresponding points in the calibration images; and estimating stereo parameters such that the calibration object is reconstructed as a planar object satisfying the constraints of correspondences derived from the calibration images. Suitable computer programs for estimating stereo parameters will be understood by one of skill in the art from the description herein. An exemplary computer is program for estimating stereo parameters available at http://www.robotic.dir.de/callab/.

The estimated stereo parameters are input to the previously-described triangulation process at block 614. At block 618, the 3D structure is recovered following the triangulation step at block 614. The stereo parameters need only be estimated when the physical setup (i.e., placement of mirrors, prism, zoom of lens) of a prism camera changes.

Although the invention is illustrated and described herein with reference to specific embodiments, the invention is not intended to be limited to the details shown. Rather, various modifications may be made in the details within the scope and range of equivalents of the claims and without departing from the invention. For example, although a stereo view imaging system is depicted, it is contemplated that multi-view images comprised of more than two images may be generated and utilized.

What is claimed:

1. A stereo capture apparatus for generating stereo content, the apparatus comprising:
a camera having a lens;
a prism positioned in front of the lens having a first surface, a second surface, and a third surface, the first surface facing the lens;
a first mirror positioned proximate to the second surface of the prism; and
a second mirror positioned proximate to the third surface of the prism.

2. The stereo capture apparatus according to claim 1, wherein said camera captures stereo still images.

3. The stereo capture apparatus according to claim 1, wherein said camera captures stereo video.

4. The stereo capture apparatus according to claim 1, wherein said camera captures stereo video and stereo still images substantially simultaneously and the stereo still images have a higher resolution than the stereo video.

5. A system for recovery of three-dimensional (3D) structures comprising:
at least one apparatus of claim 2; and
a processor that is configured to recover 3D structures from the stereo still images.

6. The system of claim 5, wherein the processor estimates disparity, stereo parameters and triangulation from the stereo still images.

7. A system for recovery of three-dimensional (3D) structures comprising:
at least one apparatus of claim 3; and
a processor that is configured to recover 3D structures from the stereo video.

8. The system of claim 7, wherein the processor estimates disparity, stereo parameters and triangulation from the stereo still images and the stereo video.

9. A system for recovery of three-dimensional (3D) structures comprising:
at least one apparatus of claim 4; and
a processor that is configured to recover 3D structures from the stereo video and the stereo still images.

10. The system of claim 9, wherein the processor estimates disparity, stereo parameters and triangulation from the stereo still images and the stereo video.

11. A system for volumetric structure recovery comprising:
at least two of the systems of claim 5; and
a processor for aligning the 3D structures recovered from the at least two systems.

12. A method for producing high resolution three-dimensional (3D) structures using the system of claim 9, comprising:
generating a transformation for mapping still image coordinates of the higher resolution still images to video image coordinates for the stereo video, the stereo video comprised of frames;
selecting one still image from said captured stereo still images for each frame of the stereo video;
warping said selected one still image to said video frame corresponding to the selected one still image using the transformation and motion estimation; and
obtaining a high resolution depth map using the warped image and disparity of the video.

13. A method for producing high resolution three-dimensional (3D) structures using the system of claim 9, comprising: estimating disparity, stereo parameters and triangulation for each image from the said system.

14. A method for producing high resolution three-dimensional (3D) structures using the system of claim 5, comprising:
aligning 3D structures estimated from different positions during motion of the system in claim 5 with respect to an object.
